(19) United States
(12) Patent Application Publication
(10) Pub. No.: US 2025/0199816 A1
(43) Pub. Date: Jun. 19, 2025

(54) QUICK BOOT THROUGH OPTIMIZED BOOT PARTITION ACCESS AND STAGED FIRMWARE LOAD FROM NON-VOLATILE MEMORY DEVICE

(71) Applicant: Micron Technology, Inc., Boise, ID (US)

(72) Inventors: Marco Redaelli, Munich, Bavaria (DE); Gaurav Sinha, Unterschleißheim, Bavaria (DE)

(21) Appl. No.: 18/941,340

(22) Filed: Nov. 8, 2024

Related U.S. Application Data
(60) Provisional application No. 63/611,871, filed on Dec. 19, 2023.

(51) Int. Cl. G06F 9/4401; G06F 13/42

(52) U.S. Cl. CPC G06F 9/4403; G06F 13/4282; G06F 2213/0026

(57) ABSTRACT

A memory sub-system includes a non-volatile memory (NVM) memory device and a processing device operatively coupled to the memory device and to a host system. The processing device includes embedded volatile memory and retrieves, in response to power on of the memory sub-system, a read-only memory (ROM) code from an internal ROM of the processing device. The processing device executes the ROM code to load a boot code, from the memory device, into the embedded volatile memory. The processing device executes the boot code to load a first stage firmware into the embedded volatile memory. The first stage firmware is to enable access to a boot partition of the memory device before the processing device has full operational access to the memory device.

### RELATED APPLICATIONS

The present application claims the benefit under 35 U.S.C. § 119 (e) of U.S. Provisional Patent Application No. 63/611,871, filed Dec. 19, 2023, which is herein incorporated by this reference.

### TECHNICAL FIELD

Embodiments of the disclosure relate generally to memory sub-systems, and more specifically, to a quick boot through optimized boot partition access and staged firmware load from a non-volatile memory (NVM) device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system according to embodiments.

FIG. 1B is a block diagram of a Peripheral Component Interconnect Express (PCIe) NVM memory footprint within the memory device of FIG. 1A according to some embodiments.

FIG. 2 is a flow chart of a method for a quick boot through optimized boot partition access and staged firmware load from a NVM device according to various embodiments.

FIG. 3 is a flow chart of a method for a quick boot through optimized boot partition access and staged firmware load from a NVM device according to an embodiment.

FIG. 4 is a block diagram of an example computer system in which embodiments of the present disclosure can operate.

### DETAILED DESCRIPTION

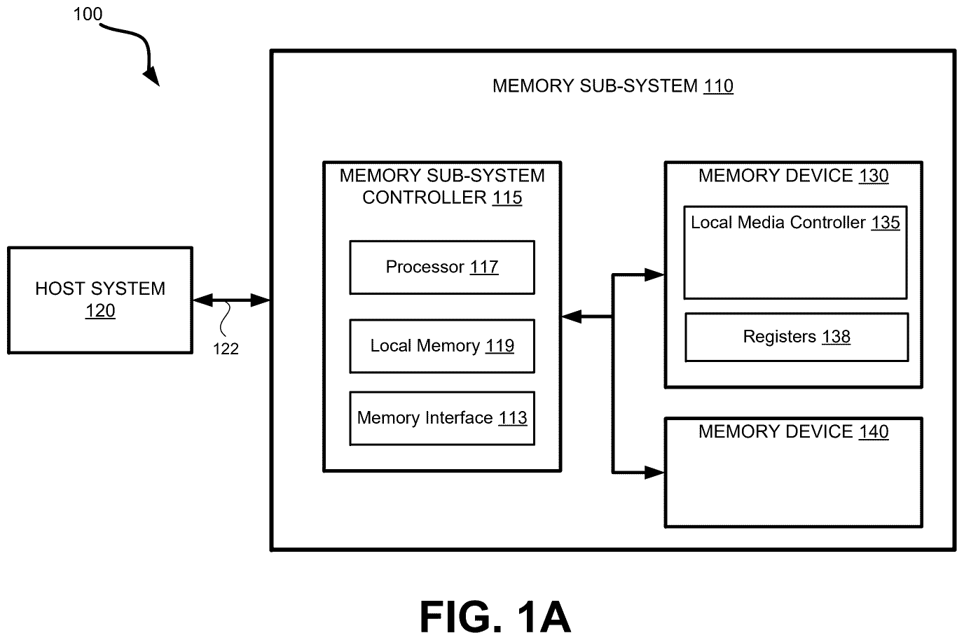

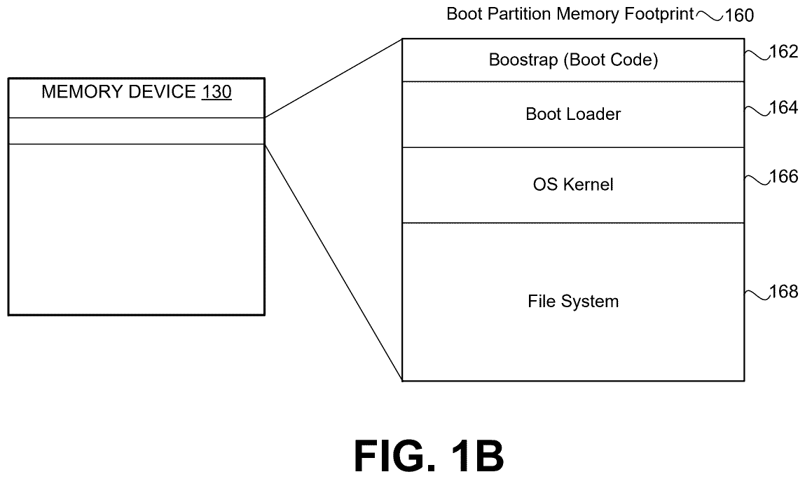

Aspects of the present disclosure are directed to a quick (or accelerated) boot through optimized boot partition access and staged firmware load from a non-volatile memory (NVM) device. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

The memory devices can be non-volatile memory devices that can store data from the host system. One example of a non-volatile memory device is a NOT-AND (NAND) memory device. Other examples of non-volatile memory devices are described below in conjunction with FIG. 1A. Each of the memory devices can include one or more arrays of memory cells that are organized in physical blocks of memory cells. A memory cell (“cell”) is an electronic circuit that stores information. Depending on the cell type, a cell can store one or more bits of binary information, and has various logic states that correlate to the number of bits being stored. The logic states can be represented by binary values, such as “0” and “1,” or combinations of such values.

In certain memory sub-systems that employ a memory controller (which includes a processing device and embedded memory), the controller performs a boot using boot firmware such as a basic input/output system (BIOS) or the newer Unified Extensible Firmware Interface (UEFI). The BIOS or UEFI firmware, once executed, supports further system booting from an NVM Express® (NVMe®) device. (While NVMe® is the current standard for most modern NVM devices, this disclosure is not limited to such current standards.)

In general, motherboards (e.g., that may include the controller and other memory sub-system components) support BIOS/UEFI boot firmware, but modern motherboards tend use flash memory for storing boot firmware. For example, serial peripheral interface (SPI) NOT-OR (or SPI-NOR) flash drives have become a common choice (particularly in automotive and industrial applications) for storing the boot firmware because of reliability and execute-in-place (XIP) capability. For example, due to this XIP capability, SPI-NOR devices do not need to first copy the boot firmware to random access memory (RAM), typically static RAM (SRAM), to be able to execute the boot firmware. These SPI-NOR flash drives, however, have disadvantages of slowing down boot, e.g., at least because the firmware is not executed out of SRAM (which has lower latency and higher data transfer rates than SPI-NOR memory), and of increasing bill of materials (BOM) costs of the motherboard.

In such memory sub-systems, the boot firmware may read the boot sector (or the EFI partition in UEFI systems) from the NVMe® device. The initial boot sector or EFI partition contains a boot loader, e.g., GRUB for may Linux® distributions or Windows Boot Manager for Windows®. The boot firmware loads the boot loader into the memory (e.g., volatile memory) of the memory sub-system. The boot loader then takes over and loads a kernel of the operating system (OS), initializing the OS boot process. Once the OS kernel is loaded and starts executing, the OS kernel uses NVMe® drivers to communicate efficiently with the NVMe® device, ensuring rapid data transfers.

The challenge with this typical boot process is that, until the OS kernel is fully available and executed, the boot process is slow, and loading the boot firmware (or executing the boot firmware out of SPI-NOR memory) can take several or more seconds, a long time in modern computing systems. Thus, significant delay is incurred before the boot firmware (UEFI or BIOS) is executed. Further, even after the boot firmware begins executing, before full data speeds can be met using peripheral component interconnect express (PCIe) data lanes that link the NVMe device and a host system, the link has to be initialized and the PCIe lanes trained. Such initialization includes detecting devices, determining the number of lanes to be used, and setting the data rate.

In modern NVM devices, PCIe signals are differential, meaning that PCIe employs a pair of wires for each lane, one for positive and one for negative. The signals on these wires need to be synchronized for proper communication. However, due to various reasons like trace length differences on the motherboard, the signal on one wire might arrive earlier than the signal on another wire. Lane training thus adjusts for these timing differences, or skews, that the signals on each pair are correctly aligned. Accordingly, PCIe lane training adds additional delay in the boot process. Even after the boot loader is loaded and executed, however, more delay is incurred waiting for the OS kernel to be loaded until the OS can be initialized. All of these delays increase time to ready (TTR), which is the time it takes from power on to the time at which the NVM device is fully functional, e.g., can support full user data memory operations from the host system.

Aspects of the present disclosure address the above and other deficiencies of the current boot methods in memory sub-systems by staging the firmware load such that a small first stage firmware (something much less than the full or main boot firmware) is first loaded into embedded volatile memory (VM) of the controller. In these embodiments, when executed, this first stage firmware provides a minimal support for boot partition access via an NVM interface with the NVM memory device. This NVM interface, by way of example in this disclosure, but that is common in the industry, may be a PCIe/NVMe® interface. Because the first stage firmware is minimized in size, the first stage firmware can be quickly loaded by the controller and executed to provide this minimal support. In various embodiments, the first stage firmware is configured to initialize the PCIe link with the host system and perform PCIe training of a single PCIe lane of the PCIe interface. In some embodiments, initializing this single PCIe lane is at a first generation data rate, e.g., which is a slower data rate, but quicker for initialization of basic functionality.

More particularly, in some embodiments, the controller retrieves, in response to power on of the memory sub-system, a read-only memory (ROM) code from an internal ROM of the controller that may also store the boot firmware (such as UEFI or BIOS). In some embodiments, the controller executes the ROM code to load a boot code, from the NVM memory device, into embedded volatile memory (VM), e.g., SRAM or tightly coupled memory. The controller may then execute the boot code to load the first stage firmware into the embedded VM. In some embodiments, the first stage firmware is executed to enable access to a boot partition of the memory device before the processing device has full operational access to the NVM memory device, meaning the host system also does not have full operational access to the NVM memory device.

In various embodiments, the controller loads, after execution of the first stage firmware, second stage firmware into one of the embedded VM or a system memory (e.g., dynamic RAM). The controller may further execute the second stage firmware to provide full operational access by the host system to the memory device, including training PCIe links of a PCIe interface of the memory device at maximum PCIe speeds. In at least some embodiments, the execution of the boot code further enables the boot loader code to be loaded (now that basic PCIe functionality has been established) from a boot partition of the NVM memory device. Execution of the boot loader code enables download and execution of the OS kernel, as explained previously. In at least some embodiments, the second stage firmware is loaded while executing at least one of the boot loader code or the OS kernel, thus enabling parallel download of the main boot firmware while moving forward with the OS boot process.

Advantages of the present disclosure include but are not limited to significantly decreasing time to ready (TTR) of the NVM memory device of a memory sub-system. The optimizations in the boot partition access based on a staged firmware load may also be performed in a way that is transparent to the host system. Further advantages include the ability to avoid using a SPI-NOR flash drive use for booting, which is slower from which to boot and involves BOM costs. These and other advantages will be discussed hereinafter, as would be apparent to those skilled in the art of memory sub-system boot and initialization.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such. Each memory device 130 or 140 can be one or more memory component(s).

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components or devices, which can be an indirect communicative connection or direct communicative connection (e.g., without intervening components or devices), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface 122, which can communicate over a system bus. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe®) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NOT-AND (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of MLC memory cells, such as bi-level cells (BLCs), triple-level cells (TLCs), quad-level cells (QLCs), and penta-level cells (PLCs) can store multiple bits per cell. In some embodiments, each of the memory devices 130 can include one or more arrays of memory cells such as SLCs, BLCs, TLCs, QLCs, PLCs or any combination of such. In some embodiments, a particular memory device can include an SLC portion, and an BLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOT-OR (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, this embedded memory includes SRAM or tightly coupled memory (TCM) that is faster-access memory than the volatile memory (VM) of the memory device 140.

In some embodiments, the local memory 119 can include memory registers storing memory pointers, fetched data, etc. The local memory 119 can also include read-only memory (ROM) for storing micro-code, e.g., which may be an internal mask ROM in some embodiments. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, the memory devices 130 are managed memory devices, which is a raw memory device combined with a local controller (e.g., the local media controller 135) for memory management within the same memory device package or memory die. An example of a managed memory device is a managed NAND (MNAND) device. Memory device 130, for example, can represent a single die or multiple dice having some control logic (e.g., local media controller 135) embodied thereon. In some embodiments, one or more components of the memory sub-system 110 are omitted.

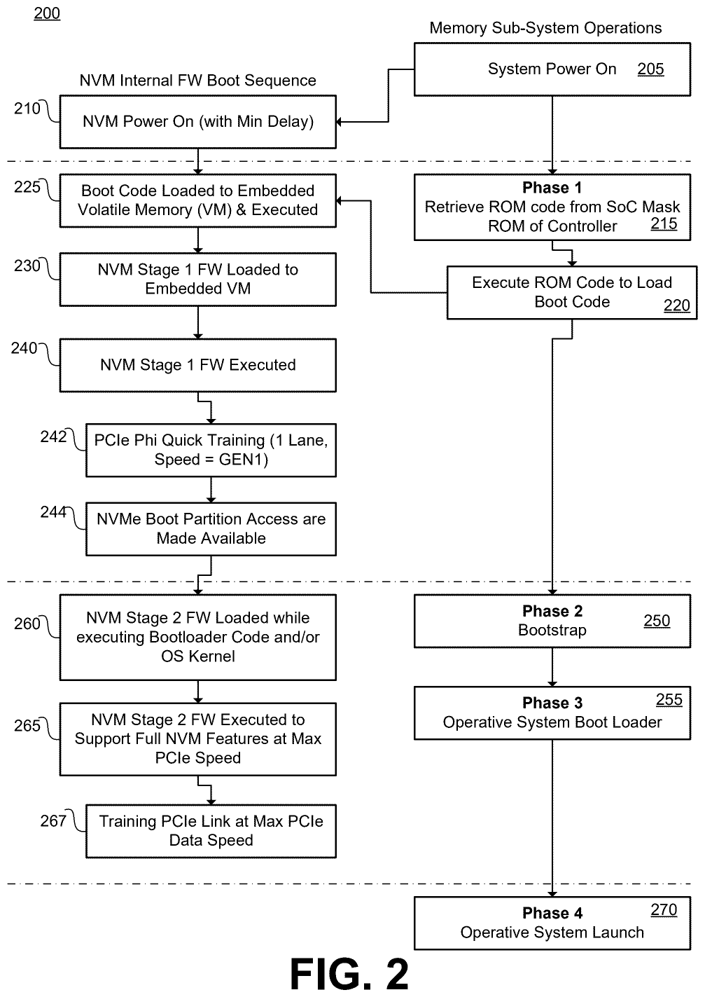

In some embodiments, the memory device 130 includes registers 138 in which to store information accessed by the controller 115 during the boot process, e.g., parameters that can be permanently stored, which direct the different stages of the firmware-driven boot of the memory device 130. For example, these parameters may include, but not be limited to, PCIe link speed and lane configurations for the boot partition access (see FIG. 2B). These registers 138, for example, may include one or more memory-mapped I/O registers or NVMe® sticky registers.

In various embodiments, the controller 115 includes a memory interface component 113. The memory interface component 113 is responsible for handling interactions of the memory sub-system controller 115 with the memory devices of the memory sub-system 110, such as the memory device 130. For example, the memory interface component 113 can send memory access commands corresponding to requests received from the host system 120 to the memory device 130, such as program commands, read commands, or other commands. In addition, the memory interface component 113 can receive data from the memory device 130, such as data retrieved in response to a read command or a confirmation that a program command was successfully performed. In some embodiments, the memory sub-system controller 115 includes at least a portion of the memory interface 113. For example, the controller 115 can include the processor 117 (e.g., a processing device) configured to execute instructions stored in the local memory 119 for performing the operations described herein. In some embodiments, the memory interface component 113 is part of the host system 120, an application, or an operating system.

FIG. 1B is a block diagram of a PCIe NVM memory footprint within the memory device 130 of FIG. 1A according to some embodiments. In some embodiments, at least one boot partition exists on the memory device 130 to store additional firmware for booting the memory device 130 as well as other system data and instructions initializing and operating an OS. More specifically, in some embodiments and by way of example, a boot partition memory footprint 160 includes a bootstrap code (e.g., a boot code 162), a boot loader code 164, an OS kernel 166, and a file system 168. At least some of this firmware and these instructions are employed by PCIe NAND devices for initialization and boot of the memory sub-system 110 for host access, and will be referred to hereinafter.

FIG. 2 is a flow chart of a method 200 for a quick boot through optimized boot partition access and staged firmware load from a NVM device according to various embodiments. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the memory interface 113 and/or the processor 117 of FIG. 1A. The method 200 will be explained in the context of overall memory sub-system operations in addition to an NVM internal firmware boot sequence performed by the controller 115. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the memory sub-system 110 is powered on, which may trigger a boot sequence in which the controller 115 seeks for a boot firmware or code to execute that will load initial hardware parameters to enable access to further firmware and/or software used to bring the memory sub-system 110 fully online.

At operation 210, the memory device 130, which is an NVM memory device, is powered on with a minimum delay compared to what is required to power on the entire memory sub-system.

At operation 215, the processing logic retrieves a read-only memory (ROM) code from an internal ROM of the processing device (e.g., the controller 115). In some embodiments, this is an internal mask ROM of the controller 115.

At operation 220, the processing logic executes the ROM code to load the boot code 162 from the memory device 130 into the embedded volatile memory (e.g., the local memory 119). In some embodiments, executing the ROM code causes detection of hardware parameters associated with loading the boot code into the embedded volatile memory such as the SRAM or TCM of the controller 115.

At operation 225, the processing logic executes the boot code 162 (or bootstrap code) to load a first stage firmware into the embedded volatile memory. For example, the boot code 162 may be a bootstrap code configured to initialize hardware of the memory sub-system 110.

At operation 230, the processing logic loads the first stage firmware into the embedded volatile memory. In some embodiments, the first stage firmware is stored on a type of NVM memory embedded on the motherboard of the controller 115, such as a ROM flash device. In some embodiments, the first stage firmware includes boot partition support features that includes peripheral component interconnect express (PCIe) and Non-volatile Memory Express (NVMe®) interface functionality.

At operation 240, the processing logic executes the first stage firmware to enable access to a boot partition of the memory device 130 before the processing device has full operational access to the memory device, meaning the host system 120 also does not yet have full operational access to the memory device 130. For example, at sub-operation 242, the processing device performs PCIe training of a single PCIe lane of the PCIe interface that exists between the host system 120 and the NVM memory device 130. In some embodiments, executing the first stage firmware further initializes the single PCIe lane at a first generation data rate, e.g., a GEN1 speed that provides PCIe functionality the soonest possible during this quick boot procedures. Further, at sub-operation 244, the processing logic secures NVMe® boot partition access and initiates a NVMe® boot of the memory device 130 from the boot partition 160 (see FIG. 1B). In some embodiments, the processing logic further retrieves PCIe lane configurations and link speeds from one or more memory-mapped I/O registers of the memory device, e.g., from the registers 138 (see FIG. 1A). The link speed for the single PCIe lane may be different than for the link speeds of all the PCIe lanes that are later trained for full data rate access of the memory device 130.

At operation 250, the processing logic begins a bootstrap phase, e.g., by executing the boot code 162 to load the boot loader code 164 from the boot partition 160 of the memory device into the system memory. In one embodiment, the system memory is the volatile memory (such as DRAM) of the memory device 140.

At operation 255, the processing logic executes the boot loader code 164 to load the OS 166 kernel into the system memory.

At operation 260, the processing logic loads, after execution of the first stage firmware, second stage firmware into one of the embedded volatile memory or the system memory. The second stage firmware may be preferably loaded into the local memory 119 (e.g., SRAM) of the controller 115, but if is too big for the local memory 119, may at least in part be loaded into the system memory on the memory device 140 (e.g., in DRAM). In at least some embodiments, the second stage firmware is loaded while executing at least one of the boot loader code or the OS kernel, thus enabling parallel download of the main boot firmware (e.g., here, the second stage firmware) while moving forward with the OS boot process.

At operation 265, the processing logic executes the second stage firmware to provide full operational access by the host system 120 to the memory device 130 at a maximum PCIe data speed. Thus, at sub-operation 267, the processing logic trains PCIe links of the PCIe interface of the memory device 130 at maximum PCIe speeds. These link speeds may be retrieved from the parameters stored in the register 138 of the memory device 130.

At operation 270, the processing logic executes (or launches) the OS kernel 166 from the system memory to initialize boot of the OS (such as Linux®, Window®, or other OS). At this point, the OS may take control of the whole memory sub-system 110 and full operational support is provided to the host system 120 for access to the memory device 130, e.g., by way of employing NVMe® drivers.

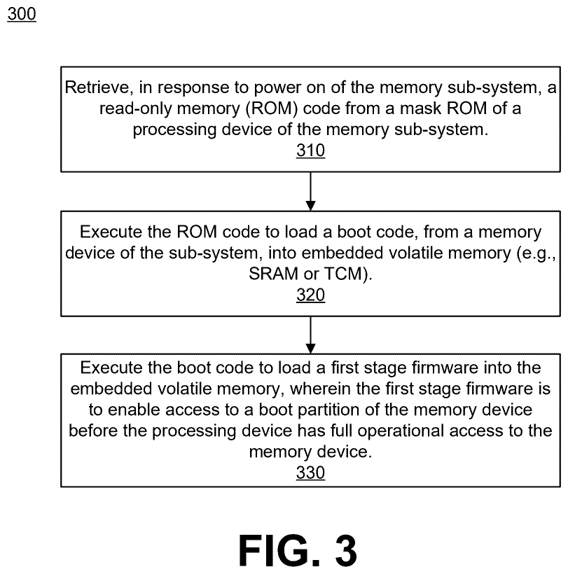

FIG. 3 is a flow chart of a method 300 for a quick boot through optimized boot partition access and staged firmware load from a NVM device according to an embodiment. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the memory interface 113 and/or the processor 117 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic retrieves, in response to power on of a memory device, a read-only memory (ROM) code from an internal ROM of the processing device.

At operation 320, the processing logic executes the ROM code to load a boot code, from the memory device, into an embedded volatile memory of the processing device.

At operation 330, the processing logic executes the boot code to load a first stage firmware into the embedded volatile memory. In some embodiments, the first stage firmware, when executed, enables access to a boot partition of the memory device before the processing logic has full operational access to the memory device.

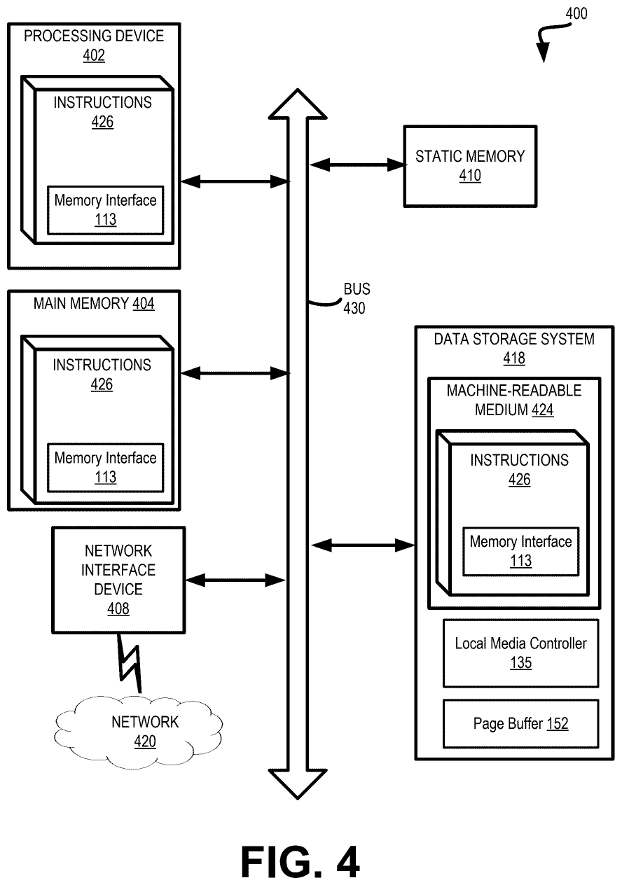

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1A) that includes, is coupled to, or utilizes a memory sub-system (e.g., the memory sub-system 110 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a non-transitory, computer-readable storage medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIGS. 1A-1C.

In one embodiment, the instructions 426 include instructions to implement functionality corresponding to the memory interface 113 of FIG. 1A. While the machine-readable storage medium 424 is shown in an example embodiment to be a single medium, the term “non-transitory computer-readable storage medium” should be taken to include a single medium or multiple media that store the one or more sets of instructions. The term “machine-readable storage medium” or “computer-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a non-transitory computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device comprising non-volatile memory; and
a processing device operatively coupled to the memory device and to a host system, wherein the processing device comprises embedded volatile memory and is to perform operations comprising:
retrieving, in response to power on of the memory sub-system, a read-only memory (ROM) code from an internal ROM of the processing device;
executing the ROM code to load a boot code, from the memory device, into the embedded volatile memory; and
executing the boot code to load a first stage firmware into the embedded volatile memory, wherein the first stage firmware is to enable access to a boot partition of the memory device before the processing device has full operational access to the memory device.

2. The memory sub-system of claim 1, wherein the boot code is a bootstrap code configured to initialize hardware of the memory sub-system.

3. The memory sub-system of claim 1, wherein the embedded volatile memory comprises static random access memory (SRAM), and wherein executing the ROM code causes detection of hardware parameters associated with loading the boot code into the SRAM.

4. The memory sub-system of claim 1, wherein the first stage firmware comprises boot partition support features that includes peripheral component interconnect express (PCIe) and Non-volatile Memory Express (NVMe®) interface functionality.

5. The memory sub-system of claim 1, further comprising a PCIe interface coupled between the processing device and the host system, wherein the operations further comprise executing the first stage firmware to:
perform PCIe training of a single PCIe lane of the PCIe interface; and
initiate a NVMe® boot of the memory device from the boot partition.

6. The memory sub-system of claim 5, wherein executing the first stage firmware is further to initialize the single PCIe lane at a first generation data rate, the operations further comprising retrieving PCIe lane configurations and link speeds from one or more memory-mapped I/O registers of the memory device.

7. The memory sub-system of claim 1, wherein the operations further comprise:
loading, after execution of the first stage firmware, second stage firmware into one of the embedded volatile memory or a system memory; and
executing the second stage firmware to provide full operational access by the host system to the memory device, including training PCIe links of a PCIe interface of the memory device at maximum PCIe speeds.

8. The memory sub-system of claim 7, wherein the operations further comprise:
loading, via execution of the boot code, a boot loader code from a boot partition of the memory device into the system memory;
executing the boot loader code to load an operating system (OS) kernel into the system memory; and
executing the OS kernel to initialize boot of an OS, wherein the second stage firmware is loaded while executing at least one of the boot loader code or the OS kernel.

9. A method comprising:
retrieving, by a processing device, in response to power on of a memory device, a read-only memory (ROM) code from an internal ROM of the processing device;
executing the ROM code to load a boot code, from the memory device, into an embedded volatile memory of the processing device; and
executing the boot code to load a first stage firmware into the embedded volatile memory, wherein the first stage firmware is to enable access to a boot partition of the memory device before the processing device has full operational access to the memory device.

10. The method of claim 9, wherein the boot code is a bootstrap code configured to initialize hardware of a memory sub-system that contains the memory device.

11. The method of claim 9, wherein executing the ROM code causes detection of hardware parameters associated with loading the boot code into the embedded volatile memory.

12. The method of claim 9, further comprising executing the first stage firmware to cause:
performing PCIe training of a single PCIe lane of a PCIe interface; and
initiating a NVMe® boot of the memory device from the boot partition.

13. The method of claim 12, wherein executing the first stage firmware is further to initialize the single PCIe lane at a first generation data rate, the method further comprising retrieving PCIe lane configurations and link speeds from one or more memory-mapped I/O registers of the memory device.

14. The method of claim 9, further comprising:
loading, after execution of the first stage firmware, second stage firmware into one of the embedded volatile memory or a system memory; and
executing the second stage firmware to provide full operational access by a host system to the memory device, including training PCIe links of a PCIe interface of the memory device at maximum PCIe speeds.

15. The method of claim 14, further comprising:
loading, via execution of the boot code, a boot loader code from a boot partition of the memory device into the system memory;
executing the boot loader code to load an operating system (OS) kernel into the system memory; and
executing the OS kernel to initialize boot of an OS, wherein the second stage firmware is loaded while executing at least one of the boot loader code or the OS kernel.

16. A non-transitory computer-readable storage medium storing instructions, which when executed by a processing device of a memory sub-system, cause the processing device to perform operations comprising:
retrieving, in response to power on of the memory sub-system, a read-only memory (ROM) code from an internal ROM of the processing device;
executing the ROM code to load, from a memory device of the memory sub-system, a boot code into an embedded volatile memory of the processing device; and
executing the boot code to load a first stage firmware into the embedded volatile memory, wherein the first stage firmware is to enable access to a boot partition of the memory device before the processing device has full operational access to the memory device.

17. The non-transitory computer-readable storage medium of claim 16, wherein the boot code is a bootstrap code configured to initialize hardware of the memory sub-system, and wherein executing the ROM code causes detection of hardware parameters associated with loading the boot code into the embedded volatile memory.

18. The non-transitory computer-readable storage medium of claim 16, wherein the operations further comprise executing the first stage firmware to cause:
performing PCIe training of a single PCIe lane of a PCIe interface, wherein training the single PCIe lane includes to operate at a first generation data rate;
initiating a NVMe® boot of the memory device from the boot partition; and
retrieving PCIe lane configurations and link speeds from one or more memory-mapped I/O registers of the memory device.

19. The non-transitory computer-readable storage medium of claim 16, wherein the operations further comprise:
loading, after execution of the first stage firmware, second stage firmware into one of the embedded volatile memory or a system memory; and
executing the second stage firmware to provide full operational access by a host system to the memory device, including training PCIe links of a PCIe interface of the memory device at maximum PCIe speeds.

20. The non-transitory computer-readable storage medium of claim 19, wherein the operations further comprise:
loading, via execution of the boot code, a boot loader code from a boot partition of the memory device into the system memory;
executing the boot loader code to load an operating system (OS) kernel into the system memory; and
executing the OS kernel to initialize boot of an OS, wherein the second stage firmware is loaded while executing at least one of the boot loader code or the OS kernel.
